(19) United States
(12) Patent Application Publication
(10) Pub. No.: US 2019/0354092 A1
(43) Pub. Date: Nov. 21, 2019

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Yuzo KATAYAMA, Kanagawa (JP)

(73) Assignee: FUJI XEROX CO., LTD., Tokyo (JP)

(21) Appl. No.: 16/352,868

(22) Filed: Mar. 14, 2019

(30) Foreign Application Priority Data
May 21, 2018 (JP) 2018-097405

(51) Int. Cl. G05B 19/418; G06Q 10/06; G06F 3/0482

(52) U.S. Cl. CPC G05B 19/41865; G05B 19/41875; G06F 3/0482; G06Q 10/0633

(57) ABSTRACT

An information processing apparatus includes an acquisition unit that acquires information on execution results of plural steps, for the plural steps included in a predetermined work; and an output unit that in a case where the predetermined work is modified, outputs information indicating a change before and after the modification is performed, for each individual step of at least some of the plural steps, based on the information on the execution results of the plural steps.

### CROSS-REFERENCE TO RELATED APPLICATIONS

This application is based on and claims priority under 35 USC 119 from Japanese Patent Application No. 2018-097405 filed May 21, 2018.

### BACKGROUND

### (i) Technical Field

The present invention relates to an information processing apparatus and a non-transitory computer readable medium storing a program.

### (ii) Related Art

As a system for supporting improvement of a step, for example, JP2006-202255A discloses a step improvement supporting system including a result aggregation unit that aggregates a work time of each step, required for each step, for a workpiece flowing through a production line, and a total step work time required from the start to the end of the production and accumulating the aggregated work time as result data, together with information on the workpiece; and a correlation analysis unit that selects a range to be improved from a distribution of all step work times of all the workpieces, and extracting one or plural steps with strong correlation in the selected range as an improvement-required step requiring improvement with reference to a work time distribution for each step of the workpiece included in the selected range.

### SUMMARY

A work including plural steps, for example, such as a work for manufacturing a product, may be modified. In this case, even in a case where a change due to the modification may be recognized throughout the work, it is difficult to recognize the change due to the modification with respect to individual steps.

Aspects of non-limiting embodiments of the present disclosure relate to an information processing apparatus which allows a change due to modification to be recognized for individual steps, in a case where a predetermined work is modified, and a non-transitory computer readable medium storing a program.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including an acquisition unit that acquires information on execution results of a plurality of steps, for the plurality of steps included in a predetermined work; and an output unit that in a case where the predetermined work is modified, outputs information indicating a change before and after the modification is performed, for each individual step of at least some of the plurality of steps, based on the information on the execution results of the plurality of steps.

### BRIEF DESCRIPTION OF THE DRAWINGS

Exemplary embodiment(s) of the present invention will be described in detail based on the following figures, wherein:

FIG. 1 is a block diagram illustrating an example of a functional configuration of a modification effect output apparatus according to the present exemplary embodiment;

FIG. 2 is a diagram showing a hardware configuration example of the modification effect output apparatus according to the present exemplary embodiment;

FIG. 3 is a flowchart showing an example of a processing procedure by the modification effect output apparatus;

FIG. 4A is a diagram showing an example of information stored in a productivity information DB;

FIG. 4B is a diagram showing an example of information stored in a quality information DB;

FIG. 4C is a diagram showing an example of information stored in a measured value information DB;

FIG. 5A is a diagram showing an example of a screen for receiving an input of modification information;

FIG. 5B is a diagram showing an example of information stored in a modification information DB;

FIG. 6 is a diagram showing an example of productivity information and quality information before M step is modified, and productivity information and quality information after the M step is modified, for each step;

FIG. 7 is a diagram showing an example of relationship points of N step and Z step;

FIG. 8 is a diagram showing an example of a result of reflecting the relationship points to productivity information and quality information of the N step and the Z step;

FIG. 9A is a diagram showing an example of information stored in the modification information DB;

FIG. 9B is a diagram showing an example of productivity information and quality information before modification, and productivity information and quality information after modification, for L step;

FIG. 10A is a diagram showing an example of correlation between the L step and each step in which modification is performed;

FIG. 10B is a diagram showing an example of a proportional division value for proportionally dividing the productivity information and a proportional division value for proportionally dividing the quality information;

FIG. 11A is a diagram showing an example in a case where a production modification rate and a quality modification rate are proportionally divided for each modified step, with respect to the L step; and

FIG. 11B is a diagram showing an example in a case where a production modification point and a quality modification point are calculated for each modified step, with respect to the L step.

### DETAILED DESCRIPTION

Hereinafter, an exemplary embodiment of the present invention will be described in detail with reference to the accompanying drawings.

Functional Configuration of Modification Effect Output Apparatus

First, the functional configuration of a modification effect output apparatus 100 according to the present exemplary embodiment will be described.

The modification effect output apparatus 100 according to the present exemplary embodiment is intended to recognize a change due to modification, in other words, an effect due to modification for individual steps, for example, in a case where a predetermined work including plural steps, such as a work of manufacturing a product, is modified.

Here, the step is each stage in a predetermined work. In a predetermined work, for example, steps are divided according to contents to be executed, and steps are divided according to a subject (an operator, a machine, or the like) which executes an operation. In other words, the predetermined work is divided into plural steps according to a predetermined standard.

In addition, in the present exemplary embodiment, the modification is to make the predetermined work different, including not only improving the work but also worsening the work.

Further, in the present exemplary embodiment, the modification effect output apparatus 100 is used as an example of the information processing apparatus.

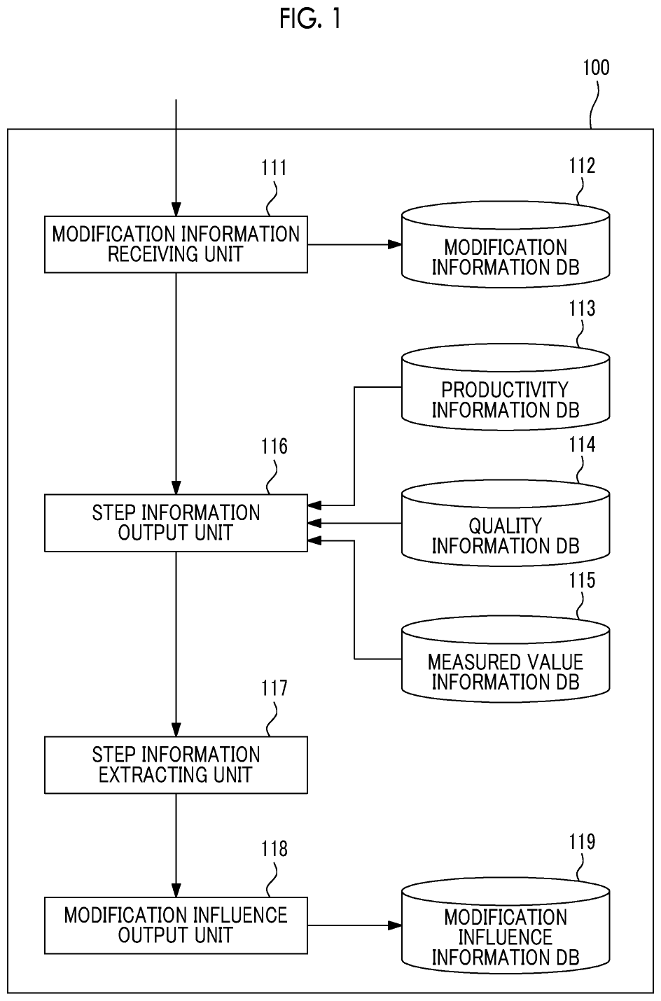

FIG. 1 is a block diagram illustrating an example of a functional configuration of the modification effect output apparatus 100 according to the present exemplary embodiment. The modification effect output apparatus 100 according to the present exemplary embodiment includes a modification information receiving unit 111, a modification information database (modification information DB) 112, a productivity information database (productivity information DB) 113, a quality information database (quality information DB) 114, a measured value information database (measured value information DB) 115, a step information output unit 116, a step information extracting unit 117, a modification influence output unit 118, and a modification influence information database (modification influence information DB) 119.

The modification information receiving unit 111 receives information on modification (hereinafter referred to as “modification information”) for a predetermined work, from the user. The modification information includes information such as the date and time at which the modification is performed, the step at which the modification is performed, and the content of modification. Here, the user may input the modification information before the modification, or may input the modification information after the modification. Details of the modification information will be described later. In the following description, a work which is a predetermined work including plural steps and whose modification is performed may be referred to as “modification execution work” in some cases. In addition, the step in which the modification has been performed (or the step in which the modification is to be performed) may be referred to as a “modified step” in some cases.

The modification information DB 112 is a database that accumulates the modification information received by the modification information receiving unit 111. As the modification information receiving unit 111 receives the modification information, the modification information is sequentially accumulated in the modification information DB 112.

The productivity information DB 113 is a database that accumulates information on the productivities of plural steps included in the predetermined work (hereinafter, information on productivity is referred to as “productivity information”). The productivity information is, for example, the production quantity of a product within a certain period of time for each step. Details of the productivity information will be described later.

Here, with respect to a work that can be subject to modification, as the work is executed, productivity information is sequentially accumulated in the productivity information DB 113. More specifically, information only on one work may be accumulated, or information on plural works may be accumulated. That is, in a case where there are plural works including plural steps, for each work, productivity information on the plural steps may be accumulated.

In the present exemplary embodiment, the productivity information is used as an example of information on the execution result.

The quality information DB 114 is a database that accumulates information on quality of plural steps included in a predetermined work (hereinafter, information on quality is referred to as “quality information”). The quality information is, for example, the number of failures of products within a certain period of time for each step. Details of the quality information will be described later.

Here, similar to the productivity information DB 113, with respect to a work that can be subject to modification, as the work is executed, quality information is sequentially accumulated in the quality information DB 114. More specifically, information only on one work may be accumulated, or information on plural works may be accumulated.

In the present exemplary embodiment, the quality information is used as an example of information on the execution result.

The measured value information DB 115 is a database that accumulates information on the measured values of plural steps included in the predetermined work (hereinafter, information on measured values is referred to as “measured value information”). The measured value information is, for example, the device temperature measured in each step. Details of the measured value information will be described later.

Here, similar to the productivity information DB 113 and the quality information DB 114, with respect to a work that can be subject to modification, as the work is executed, measured value information is accumulated in the measured value information DB 115. More specifically, information only on one work may be accumulated, or information on plural works may be accumulated.

In a case where the predetermined work (that is, the modification execution work) is modified, the step information output unit 116 outputs information indicating a change before and after the modification is performed, for individual steps of at least some of the plural steps included in the work.

Here, the step information output unit 116 acquires the productivity information stored in the productivity information DB 113 and the quality information stored in the quality information DB 114 for plural steps included in the modification execution work. Then, based on the acquired productivity information and quality information, the step information output unit 116 outputs productivity information and quality information before modification is performed and productivity information and quality information after modification is performed, for individual steps of at least some of plural steps included in the modification execution work.

More specifically, for example, the step information output unit 116 specifies a work corresponding to the modification execution work, a step (a modified step) in which the modification is performed in the work, the date and time at which the modification is performed, and the like, based on the modification information received by the modification information receiving unit 111. Then, the step information output unit 116 outputs productivity information and quality information for one hour retroactively from the date and time at which the modification is performed, and productivity information and quality information for one hour after the date and time at which the modification is performed, for each step performed for one hour before and after the date and time at which the modification is performed, among the plural steps included in the modification execution work.

In addition, the period (hereinafter referred to as information output period) for which productivity information and quality information are output is not limited to one hour. For example, a period such as one hour, one day, or one week is set in advance for the information output period. Further, the user may change the information output period from a default value to a different value, or newly input the value of the information output period.

The step information extracting unit 117 specifies a step estimated to be largely changed due to the modification, among the plural steps included in the modification execution work. Then, the step information extracting unit 117 extracts (outputs) the information on the specified step, from the information output by the step information output unit 116.

More specifically, for example, it is estimated that a step prior to the modified step is less affected by modification than a step subsequent to the modified step. Therefore, the step information extracting unit 117 specifies steps subsequent to the modified step, excluding steps prior to the modified step, based on the relationship between the modified step and individual steps, among the plural steps included in the modification execution work. Then, the specified step is estimated to be a step with a large change due to modification, and productivity information and quality information before and after the modification are extracted for the step.

Further, for example, the step information extracting unit 117 specifies a step in which the amount of change before and after the modification is performed is equal to or greater than a predetermined threshold, from among the plural steps included in the modification execution work. Then, the specified step is estimated to be a step with a large change due to modification, and productivity information and quality information before and after the modification are extracted for the step.

The modification influence output unit 118 further reflects the relationship between the modified step and each individual step in the productivity information and the quality information of each individual step extracted by the step information extracting unit 117.

More specifically, the modification influence output unit 118 calculates a relationship point indicating the relationship with the modified step, for each individual step. The relationship point is calculated based on the relationship between the modified step and each individual step. The greater the relationship with the modified step, the greater the value of the relationship point.

For example, the modification influence output unit 118 estimates that the first step, which is a step subsequent to the modified step, has a larger change due to modification than the second step which is a step subsequent to the first step. That is, since the first step is a step closer to the modified step than the second step, the first step is estimated to be largely changed due to the modification. More specifically, for example, the modification influence output unit 118 estimates that the change due to modification is larger in the step within three steps from the modified step than the step separated by four or more steps from the modified step. Then, one point of relationship point is given.

Further, for example, the modification influence output unit 118 estimates that the step of handling the identical object to the object which is subjected to the modification in the modified step has a larger change due to modification than the step of not handling the object. For example, the modification influence output unit 118 gives one point of relationship point to the step of handling the identical object to the object which is subjected to the modification in the modified step.

The object which is subjected to the modification is a product handled in the modified step (that is, a product generated by a modification execution work) and a part included in the product.

As an example, a description will be given of a case of calculating a relationship point for a step performed after the modified step. First, the next step of the modified step is a step within three steps from the modified step. Therefore, one point is given. In the next step of the modified step, in a case of handling the identical product and the identical part to the modified step, one point by the identical product and one point by the identical part are respectively given. As a result, the relationship point of the next step of the modified step is calculated as 3 points.

In a case where the step is within three steps, in the case of the identical product, the value of a point to be given may be changed, instead of equally giving one point to each identical part. For example, in a case where the step is within three steps, three points may be given, and in the case of the identical product, one point may be given for each identical part.

Further, in this example, one point is given to the step within three steps from the modified step, but it is not limited to three steps. The value of this step may be changed according to, for example, the content of the modification execution work, the environment in which the modification execution work is performed, the content of the modified step, the product or part to be modified, and the like. Further, the value of the point to be given may be changed according to the number of steps from the modified step. For example, three points may be given to the step within three steps from the modified step, two points may be given to four to six steps from the modified step, and one point may be given to seven to nine steps from the modified step.

Further, the value of the point to be given may be changed according to the degree of matching with the content of the modified step (how close it is with the content of the modified step). For example, in the example described above, points are given to the steps subsequent to the modified step, but in a case where a step including the identical work to the work modified in the modified step is present before the modified step, as a result, the step will also be modified. As described above, the relationship point may be given to the steps prior to the modified step, based on the contents of the modified step.

In this manner, the modification influence output unit 118 calculates a relationship point for each individual step. Then, the productivity information and the quality information in which the calculated relationship point is reflected is output.

The modification influence information DB 119 is a database that accumulates the information output by the modification influence output unit 118. The information output by the modification influence output unit 118 indicates a change due to modification, for the step included in the modification execution work. By referring to the information stored in the modification influence information DB 119, the user can check the influence due to the modification and the step with a large change due to the modification.

In the present exemplary embodiment, the step information output unit 116 is used as an example of an acquisition unit. As an example of the output unit, the step information output unit 116, the step information extracting unit 117, and the modification influence output unit 118 are used.

Hardware Configuration of Modification Effect Output Apparatus

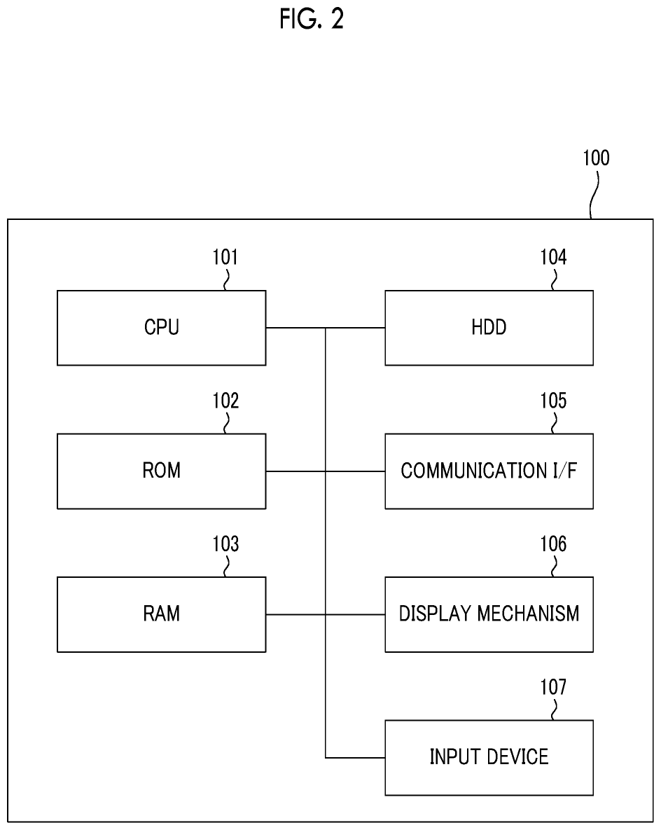

Next, the hardware configuration of the modification effect output apparatus 100 according to the present exemplary embodiment will be described. FIG. 2 is a diagram showing a hardware configuration example of the modification effect output apparatus 100 according to the present exemplary embodiment.

As shown in FIG. 2, the modification effect output apparatus 100 includes a central processing unit (CPU) 101 as a computing unit, a read only memory (ROM) 102 as a storage area for storing programs such as a basic input output system (BIOS), and a random access memory (RAM) 103 which is a program execution area. Further, the modification effect output apparatus 100 includes a hard disk drive (HDD) 104 which is a storage area for storing various programs such as an operating system (OS) and applications, input data for various programs, output data from various programs, and the like.

Further, the modification effect output apparatus 100 includes a communication interface (communication I/F) 105 for communicating with the outside, a display mechanism 106 including a display, and an input device 107 such as a keyboard, a mouse, and a touch panel.

Each functional unit constituting the modification effect output apparatus 100 is realized by cooperation of software and hardware resources. Specifically, for example, in a case where the modification effect output apparatus 100 is realized by the hardware configuration shown in FIG. 2, by various programs stored in the HDD 104 and the like being read into the RAM 103 and executed by the CPU 101, functional units such as the modification information receiving unit 111, the step information output unit 116, the step information extracting unit 117, the modification influence output unit 118, and the like shown in FIG. 1 are realized. Further, the modification information DB 112, the productivity information DB 113, the quality information DB 114, the measured value information DB 115, and the modification influence information DB 119 are realized by the HDD 104, for example.

Processing Procedure of Modification Effect Output Apparatus

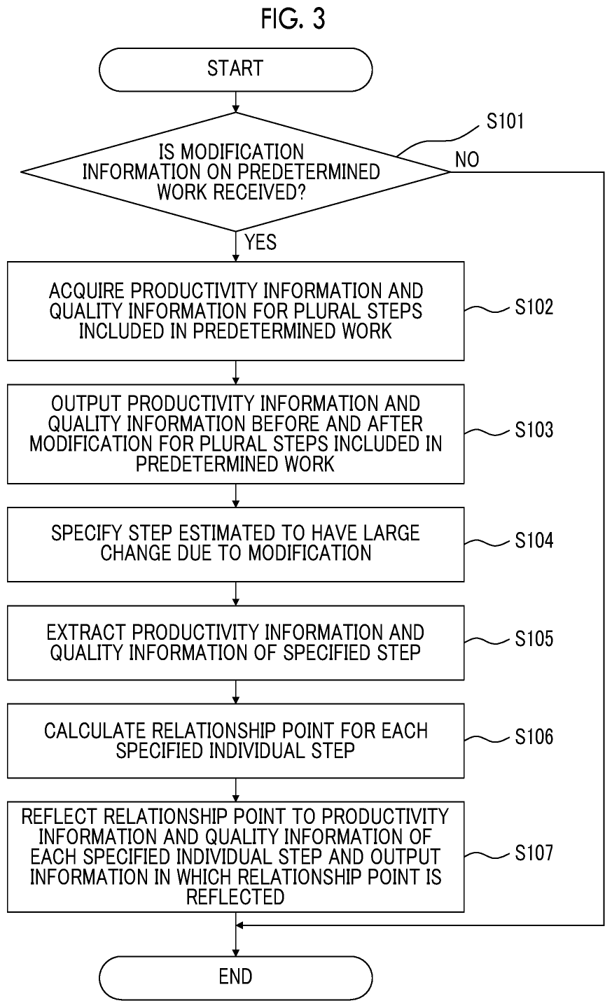

Next, a processing procedure by the modification effect output apparatus 100 will be described. FIG. 3 is a flowchart showing an example of a processing procedure by the modification effect output apparatus 100. The process shown in FIG. 3 is performed periodically (for example, every minute).

First, the modification information receiving unit 111 determines whether or not modification information on a predetermined work has been received from the user (step S101).

In a case where a negative determination (NO) is made in step S101, the processing flow ends.

On the other hand, in a case where an affirmative determination (YES) is made instep S101, the step information output unit 116 acquires the productivity information stored in the productivity information DB 113 and the quality information stored in the quality information DB 114, for plural steps included in a predetermined work (that is, a modification execution work) in which the modification according to the modification information in step S101 has been performed (step S102).

Next, the step information output unit 116 outputs productivity information and quality information before and after modification for the plural steps included in the predetermined work (modification execution work) (step S103). Next, the step information extracting unit 117 specifies a step estimated to be largely changed due to the modification, among the plural steps included in the predetermined work (modification execution work) (step S104). Next, the step information extracting unit 117 extracts the productivity information and the quality information of the step specified in step S104 from the productivity information and the quality information output by the step information output unit 116 (step S105).

Next, the modification influence output unit 118 calculates a relationship point for each individual step specified in step S104 (step S106). Next, the modification influence output unit 118 reflects the relationship point to the productivity information and the quality information of each individual step extracted in step S105 and outputs the information in which the calculated relationship point is reflected (step S107). The output information is stored in the modification influence information DB 119. Then, the processing flow ends.

Description of Information of Various Databases

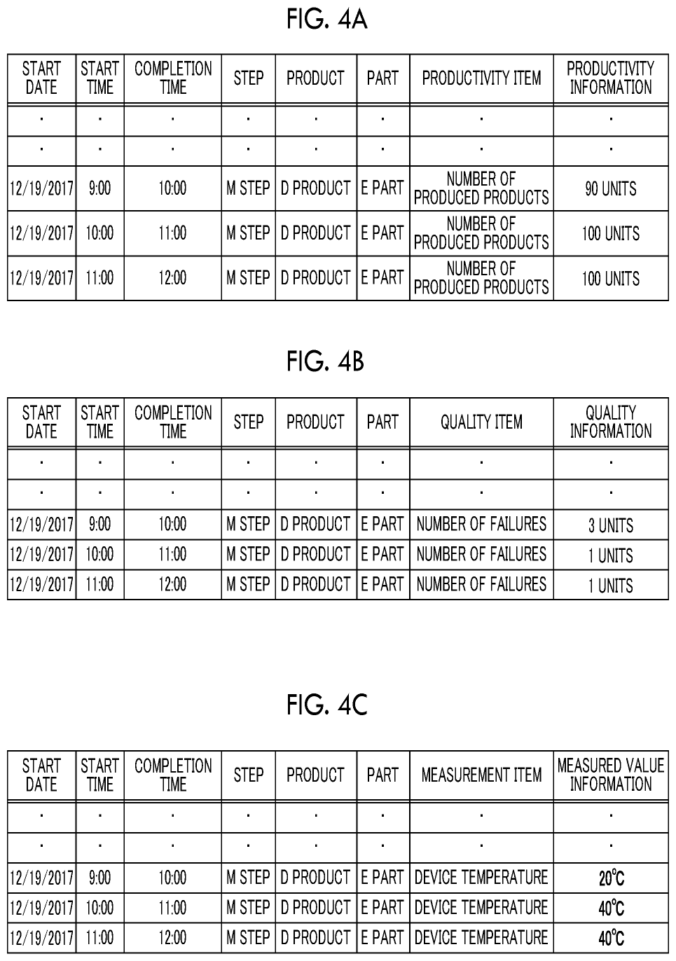

Next, the information stored in the productivity information DB 113, the quality information DB 114, and the measured value information DB 115 will be described. FIG. 4A is a diagram showing an example of information stored in the productivity information DB 113. FIG. 4B is a diagram showing an example of information stored in the quality information DB 114. FIG. 4C is a diagram showing an example of information stored in the measured value information DB 115.

First, the information stored in the productivity information DB 113 will be described with reference to FIG. 4A.

“Start date” is the date on which the productivity information is recorded, “start time” is the time to start recording of the productivity information, “completion time” is the time to complete the recording of the productivity information, “step” isastepin which productivity information is recorded, “product” is a product handled in a step in which productivity information is recorded, “part” is a part handled in a step in which productivity information is recorded, “productivity item” is an item representing the type of productivity information, and “productivity information” is productivity information on the “productivity item” of the target in the corresponding step.

In the illustrated example, it is indicated that productivity information of M step is shown, among all the steps included in the predetermined work. The M step is a step for handling the E part of the D product, and for example, it is indicated that the number of D products subjected to the M step is 90 during a period from 9 o'clock to 10 o'clock on Dec. 19, 2017. Similarly, it is indicated that during the period from 10 o'clock to 11 o'clock, the number of D products subjected to the M step is 100, and during the period from 11 o'clock to 12 o'clock, the number of D products subjected to the M step is 100.

In this example, the production quantity of the product is indicated as the productivity information, but the productivity information may be information indicating the productivity of the step. For example, as productivity information, a tact time (step work time) may be used.

Next, the information stored in the quality information DB 114 will be described with reference to FIG. 4B.

“Start date”, “start time”, “completion time”, “step”, “product”, and “part” are the identical to those in FIG. 4A. In addition, “quality item” is an item representing the type of quality information, and “quality information” is quality information on the “quality item” of the target in the corresponding step.

In the illustrated example, it is indicated that the quality information of the M step is shown, among all the steps included in the predetermined work. For example, it is indicated that during the period from 9 o'clock to 10 o'clock on Dec. 19, 2017, the number of D products that become defective in the M step is three. Similarly, it is indicated that during the period from 10 o'clock to 11 o'clock, the number of D products that become defective in the M step is one, and during the period from 11 o'clock to 12 o'clock, the number of D products that become defective in the M step is one.

In this example, the number of failures (here, the number of defective products) is shown as the quality information, but the quality information may be information indicating the quality of the step. For example, as the quality information, the number of stops of a step within a certain period may be used.

Next, the information stored in the measured value information DB 115 will be described with reference to FIG. 4C.

“Start date”, “start time”, “completion time”, “step”, “product”, and “part” are the identical to those in FIG. 4A. The “measurement item” is an item representing the type of the measured value information, and the “measured value information” is measured value information in the corresponding step.

In the illustrated example, the measured value information of the M step is shown, among all the steps included in the predetermined work. For example, it is indicated that during the period from 9 o'clock to 10 o'clock on Dec. 19, 2017, the device temperature measured in the M step is 20° C. Similarly, it is indicated that during the period from 10 o'clock to 11 o'clock, the temperature of the device measured in the M step is 40° C., and during the period from 11 o'clock to 12 o'clock, the device temperature measured in the M step is 40° C.

The device temperature is, for example, the temperature of a manufacturing device used for manufacturing a product (in this example, D product) or the temperature of a product (D product). Further, in this example, the device temperature is indicated as the measured value information, but the measured value information may be information indicating the measured value measured in the step. For example, as the measured value information, the pressure applied to the manufacturing device or the product at the time of executing the step, or the air temperature, atmospheric pressure, humidity, or magnetic field at the place where the step is executed may be used.

In this way, the productivity information, the quality information, and the measured value information for every hour are stored in the productivity information DB 113, the quality information DB 114, and the measured value information DB 115, for example.

However, the unit for storing the productivity information, the quality information, and the measured value information is not limited to one hour. For example, it may be stored in units of 1 minute, 10 minutes or the like. Further, for example, productivity information may be stored in the productivity information DB 113 every time a product is produced (that is, every time the number of units in the productivity information is added), or quality information may be stored in the quality information DB 114 every time a defective product is generated (that is, every time the number of cases in the quality information is added).

In the illustrated example, in the information on the M process has been described. However, the productivity information DB 113, the quality information DB 114, and the measured value information DB 115, pieces of information on all the steps included in the predetermined work (for example, A step to Z step) are sequentially stored.

Specific Example of Process of Modification Effect Output Apparatus

Next, the process of the modification effect output apparatus 100 will be described with a specific example.

In this example, it is assumed that the work of producing the D product is modified. That is, the work of producing the D product is a modification execution work. Specifically, the work of producing the D product includes A step to Z step, and respective steps are sequentially executed for one product. On the other hand, respective steps are executed in parallel for plural products. Under such circumstances, it is found that seal floating occurs in the M step among A step to Z step and the number of defective devices increases. Therefore, in a case where the modification “seal pressure increase” is performed in the M step, the change (effect) due to the modification is output by the modification effect output apparatus 100.

In addition, the following steps correspond to the respective steps of FIG. 3.

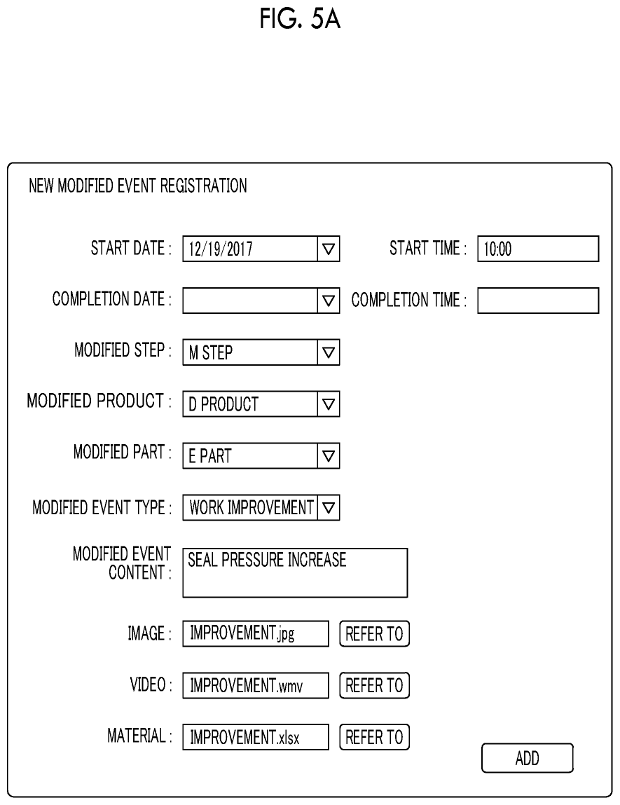

First, the modification information receiving unit 111 receives modification information from the user. FIGS. 5A and 5B are diagrams for explaining an example of modification information. FIG. 5A is a diagram showing an example of a screen for receiving an input of modification information. Further, FIG. 5B is a diagram showing an example of information stored in the modification information DB 112.

In the example shown in FIG. 5A, the start date of modification is input as “Dec. 19, 2017”, the start time is input as “10 o'clock”, and a work proceeds with the modified steps since 10 o'clock on Dec. 19, 2017. In addition, the step in which the modification is performed is “M step”, the product to be modified is “D product”, and the part to be modified is input as “E part” . In addition, the modified event type is input as “work improvement”, and the modified event content is input as “seal pressure increase”.

Here, in order to indicate the content of modification in more detail, files such as images or videos capturing the state of modification and materials for explaining the content of modification may be registered. In the illustrated example, an image file “improvement.jpg”, a video file “improvement.wmv”, and a file of material “improvement.xlsx” are registered.

As the modification information shown in FIG. 5A is input, the modification information shown at the bottom of FIG. 5B is newly registered in the modification information DB 112.

In a case where the modification information receiving unit 111 receives modification information (YES in step S101), the modification is performed, and thereafter, the step information output unit 116 acquires the productivity information stored in the productivity information DB 113 and the quality information stored in the quality information DB 114 for A step to Z step (step S102). More specifically, the step information output unit 116 acquires the productivity information stored in the productivity information DB 113 and the quality information stored in the quality information DB 114 for A step to Z step. Then, the step information output unit 116 outputs the productivity information and the quality information of the time retroactively from the start time and the productivity information and the quality information of the time after the start time, based on the start time of modification, for A step to Z step (step S103).

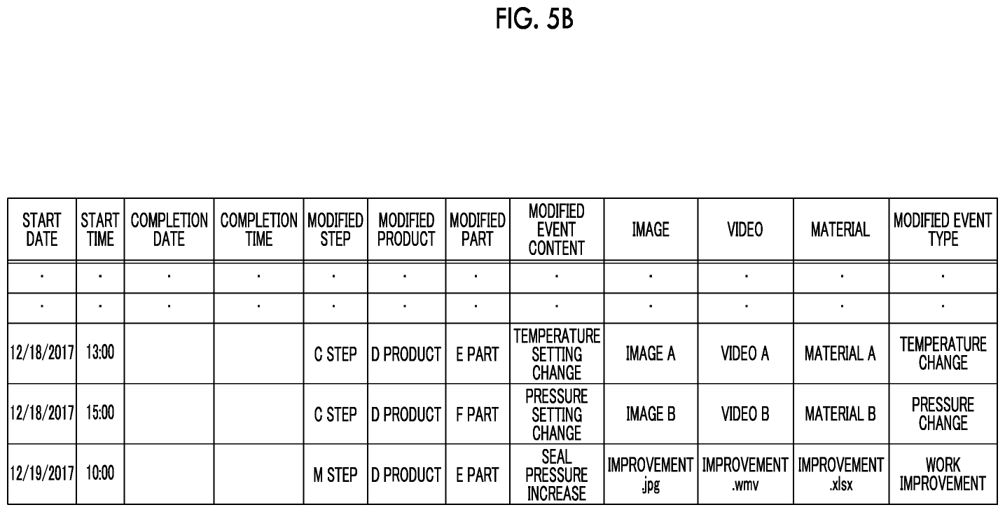

FIG. 6 is a diagram showing an example of productivity information and quality information before the M step is modified, and productivity information and quality information after the M step is modified, for each step.

“Start date” indicates the date on which productivity information and quality information are output, “start time” indicates the start time of the period for outputting productivity information and quality information, and “completion time” indicates the completion time of the period for outputting productivity information and quality information.

Further, “modified step” is a step in which modification is performed, “modified product” is a product to be modified, “modified part” is a part to be modified, and “modified event content” is contents of modification.

Further, “spreading step” is the step of outputting productivity information and quality information, “spreading product” is the product handled in the spreading step, “spreading part” is the part handled in the spreading step, “productivity information” is the productivity information of the spreading step, “quality information” is the quality information of the spreading step, and “modified event type” is a type of modification.

Here, from the modification information received by the modification information receiving unit 111, the step information output unit 116 specifies that the date and time at which the modification is performed is “10 o'clock on Dec. 19, 2017”. Further, in this example, the information output period is preset as “1 hour”. In this case, the step information output unit 116 outputs the productivity information and the quality information at 9 o'clock to 10 o'clock on Dec. 19, 2017 and the productivity information and the quality information at 10 o'clock to 11 o'clock on Dec. 19, 2017, for A step to Z step.

In the illustrated example, information on L step to P step and Z step is shown, among A step to Z step. In addition, the step information output unit 116 does not output the productivity information and the quality information for steps that are not executed at 9 o'clock to 11 o'clock on Dec. 19, 2017, among A step to Z step.

Next, the step information extracting unit 117 specifies a step estimated to be largely changed due to modification of the M step, among A step to Z step (step S104).

Here, the step information extracting unit 117 excludes steps prior to the modified M step among A step to Z step, and specifies steps subsequent to the M step. For example, the L step is excluded and the steps N to Z are specified.

The step information extracting unit 117 specifies a step in which the rate of change due to modification of the productivity information and the quality information is 10% or more (10% or more or or less). For example, the O step is excluded because the amount of change in the productivity information is zero. Further, the P step is also excluded because the rate of change due to modification of productivity information (hereinafter referred to as production modification rate) is less than 10%. On the other hand, in the N step and Z step, the production modification rate is (110 units−100 units)/100 units=10%. Furthermore, the rate of change (hereinafter referred to as a quality modification rate) due to modification of quality information is (4 cases−2 cases)/4 cases=50%.

Therefore, the O step and the P step are excluded, and the N step and the Z step are specified. In this manner, N step and Z step among A step to Z step are specified as steps estimated to be largely changed due to modification of the M step.

In this example, the threshold of the step specified by the step information extracting unit 117 is set to 10%, but it is not limited to 10%. Further, the threshold may be changed according to, for example, the content of the modification execution work, the content of the modified step, the product or part to be modified, and the like. Furthermore, the threshold may be changed by the production modification rate and the quality modification rate.

Further, in this example, in a case where both the production modification rate and the quality modification rate exceed the threshold, it is estimated that the change due to the modification is large. However, in a case where at least one of the production modification rate or the quality modification rate exceeds a threshold, it maybe estimated that the change due to the modification is large.

Next, the step information extracting unit 117 extracts the productivity information and the quality information of the N step and the Z step specified in step S104 from the productivity information and the quality information output by the step information output unit 116 (step S105). Next, the modification influence output unit 118 calculates a relationship point for each step of the N step and the Z step (step S106).

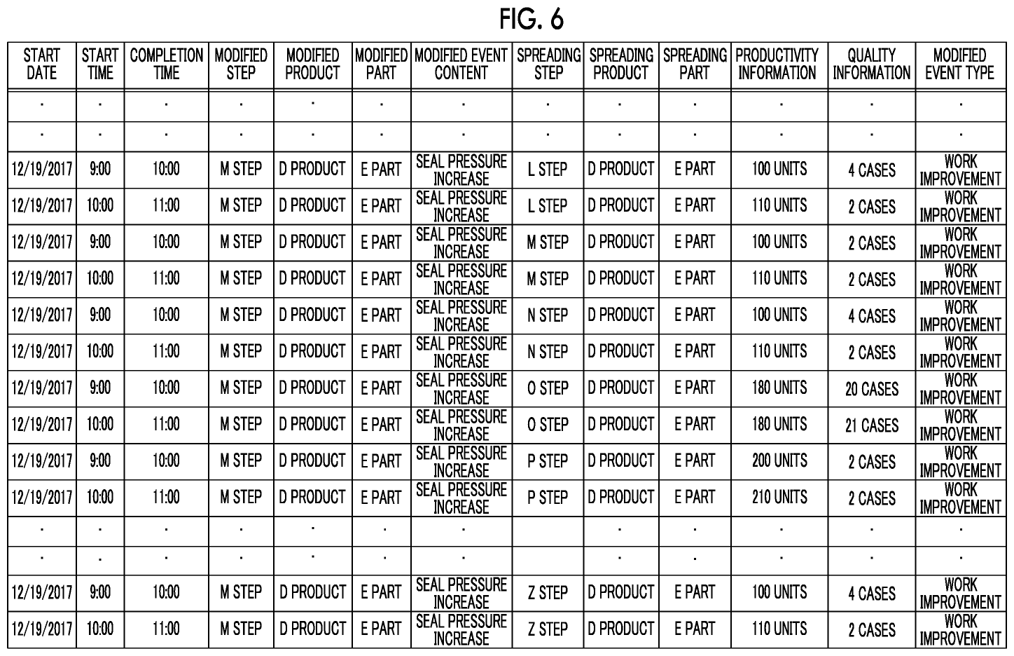

FIG. 7 is a diagram showing an example of the relationship points of the N step and the Z step.

Here, since the N step is a step within three steps from the modified step (M step), one point is given. The “spreading product” and the “spreading part” of the N step are a D product and an E part, respectively, which are identical to “modified product” and “modified part”. Therefore, two points are given. As a result, the modification influence output unit 118 sets the relationship point of the N step to three points.

Similarly, the modification influence output unit 118 sets the relationship point of the Z step to two points.

Next, the modification influence output unit 118 reflects the calculated relationship point to the productivity information and the quality information of the N step and the Z step, and outputs the information in which the calculated relationship point is reflected (step S107).

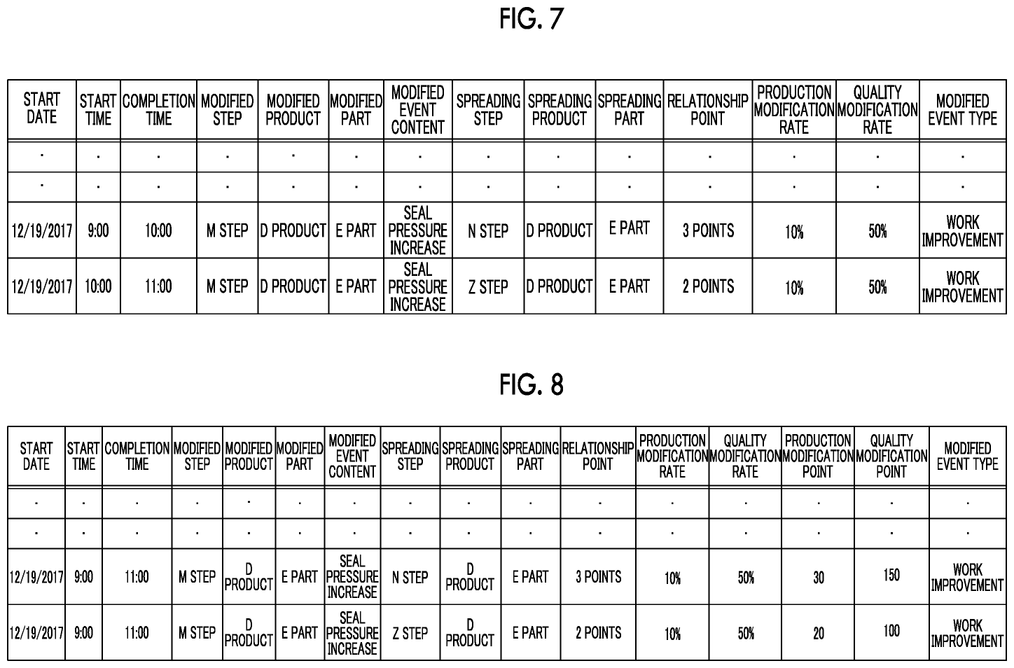

FIG. 8 is a diagram showing an example of a result of reflecting the relationship points to the productivity information and the quality information of the N step and the Z step.

The production modification rate and the quality modification rate of the N step and Z step are 10% and 50%, respectively. In addition, the relationship points of the N step and the Z step are 3 points and 2 points, respectively. From these values, the production modification points and the quality modification points of N step and Z step are calculated. The production modification point is obtained by reflecting the relationship point in the productivity information, and the quality modification point is obtained by reflecting the relationship point in the quality information.

Specifically, the production modification point of the N step is calculated as the production modification rate (10%)×the relationship point (3 points)=30 points, and the quality modification point of the N step is calculated as the quality modification rate (50%)×the relationship point (3 points)=150 points. Similarly, the production modification point of the Z step is calculated as the production modification rate (10%)×the relationship point (2 point)=20 points, and the quality modification point of the Z step is calculated as the quality modification rate (50%)×the relationship point (2 point)=100 points.

Various types of information of FIG. 8 including the production modification point and the quality modification point are stored in the modification influence information DB 119. By referring to the information stored in the modification influence information DB 119, the user can understand that the N step and the Z step are steps with a large change due to the modification. In addition, the user can recognize the extent of the change due to the modification of the M step, based on the production modification points and the quality modification points in the N step and the Z step.

To explain further, as shown in FIG. 6, even in a case of referring to the information output by the step information output unit 116, the user can recognize the change due to the modification with respect to individual steps. However, as shown in FIG. 8, by reflecting the relationship point for each individual step, the influence of the modification is further emphasized, and the user can recognize the change due to the modification with respect to each individual step.

In other words, in the example described above, the production modification rate and the quality modification rate of each of the N step and the Z step are 10% and 50%, respectively. On the other hand, the relationship point is larger in the N step than in the Z step. As a result, finally, it is understood that the production modification point and the quality modification point are larger in the N step than in the Z step, and are greatly affected by the modification.

For example, it is considered that the production modification rate and the quality modification rate are increased due to factors not related to modification. Therefore, by giving the relationship point to the step estimated to be easily influenced by the modification, it is easier to recognize the change due to the modification as compared with the case where the relationship point is not given.

In the present exemplary embodiment, the step information extracting unit 117 may not specify a step estimated to be largely changed due to modification. That is, the modification influence output unit 118 may calculate the relationship point for individual step of plural steps (in this example, A step to Z step) included in the modification execution work, reflect the relationship point to the productivity information and the quality information of each individual step and output the information in which the relationship point is reflected. Even in such a case, the user can check the step with a large change due to the modification and the degree of the change due to the modification in each step, based on the information stored in the modification influence information DB 119.

Further, in this example, the works in respective steps are performed consecutively on the basis of the date and time when the modification is performed, but there may be steps that are performed only for the limited time of one day, for example. With respect to such steps, as information before and after the modification, for example, productivity information and quality information in the identical time zone of one day before and after modification are output. For example, it is assumed that there is a step performed every day from 12 o'clock to 13 o' clock. Here, in a case where the date and time at which the modification is performed is “10 o'clock on Dec. 19, 2017”, for example, the productivity information and the quality information at 12 o'clock to 13 o'clock on December 18, which is the day before the modification, and the productivity information and the quality information at 12 o'clock to 13 o' clock on December 19, which is the day of the modification are output.

Further, depending on a step, it may be performed only on a limited day of one week or a limited week of one month, rather than a limited time of one day. Therefore, productivity information and quality information before and after the modification may be output in cycles of a certain day, daily, weekly, monthly, yearly, or the like, depending on the execution state of the step.

In addition, the information output period may be varied according to the content of modification. For example, the information output period is set according to the content of modification, such as one hour in a case where the modification is “seal pressure increase”, and two hours in a case where the modification is “part exchange”.

In addition, the information output period may be varied according to the values of productivity information and quality information. For example, in a case where the number of produced products within a certain period is several hundreds, the number of produced products is larger than in a case where the number of produced products within a certain period is several, so the information output period is set to be shorter.

Further, the period until the modification effect occurs may be set as the information output period. For example, focusing on a certain step, in a case where the difference between pieces of the productivity information before and after the modification exceeds a predetermined threshold, the period before and after the modification may be set as the information output period.

For the productivity information and the quality information, the information output periods may be the identical period or may be different periods.

Description of Case Where Plural Modifications are Performed

Next, a case where plural modifications are performed in the modification execution work will be described. For example, in a case where plural modifications are performed at the identical time (that is, within a certain period), productivity information and quality information change due to each modification. Therefore, the modification effect output apparatus 100 outputs information indicating a change corresponding to each of plural modifications for each individual step. More specifically, based on the correlation between each individual step and each of the plural modified steps, the modification effect output apparatus 100 proportionally divides the amount of change in productivity information and quality information of each individual step for each modification. As a result, for each individual step, the influence of each modification is recognized.

Here, as a specific example, it is assumed that modification is performed in A step, B step, and C step at the identical time in the modification execution work including A step to Z step. In addition, focusing on an L step out of A step to Z step, a case of proportionally dividing the change amount of productivity information and quality information will be described.

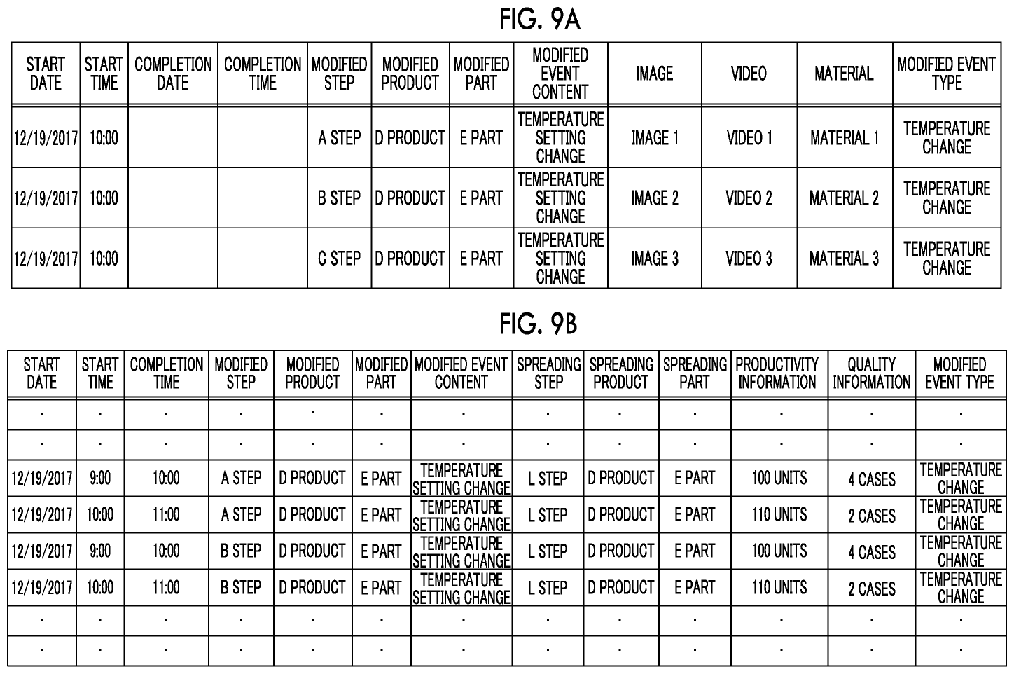

FIG. 9A is a diagram showing an example of information stored in the modification information DB 112. In the illustrated example, as in FIG. 5B, information on steps A to C where modification is performed is shown. The start date of modification is “Dec. 19, 2017”, and the start time is “10 o'clock”. Further, the product to be modified is “D product”, and the part to be modified is “E part”. Further, the modified event content is “temperature setting change”, and the modified event type is “temperature change”. The modified event of the temperature setting change is to change the setting of, for example, the temperature of a manufacturing device, the temperature of the product, the air temperature in the room, and the like. Image files and video files are also registered.

FIG. 9B is a diagram showing an example of productivity information and quality information before modification, and productivity information and quality information after modification, for L step. In the illustrated example, similarly to FIG. 6, information representing the change before and after modification is shown for the L step. In this example, only the information on the L step is shown, but the step information output unit 116 outputs the information representing the change before and after the modification even for other steps (A step to Z step other than the L step).

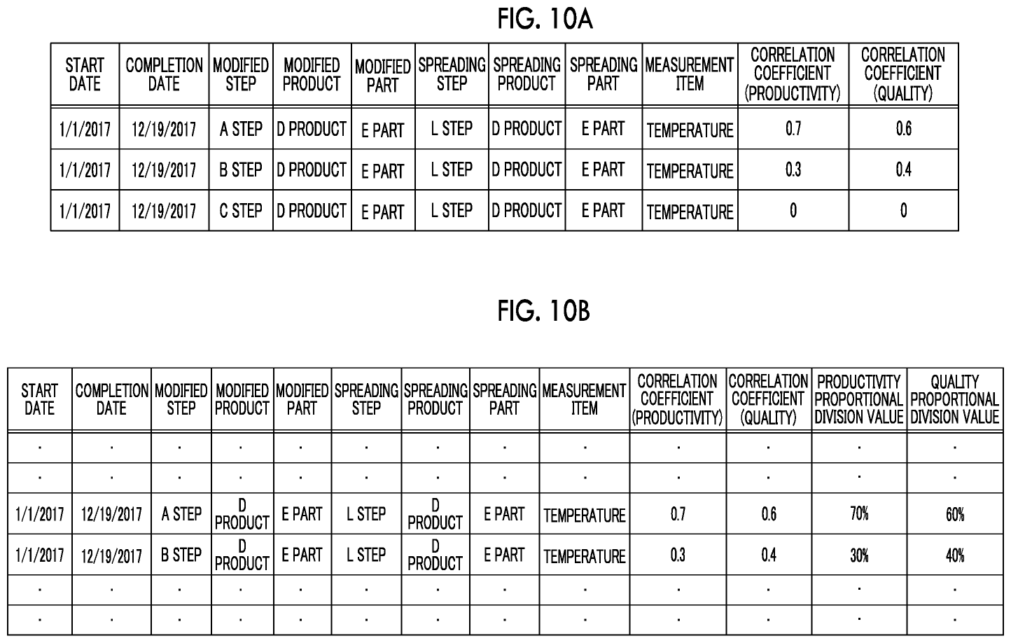

Then, the modification influence output unit 118 calculates the correlation between the L step and each of the modified steps A to C. FIG. 10A is a diagram showing an example of correlation between the L step and each step in which modification is performed. In this example, only the correlation between the L step and the A step to the C step is shown, but in reality, the modification influence output unit 118 calculates the correlation with the A step to the C step for other steps (A step to Z step other than the L step). Further, for example, the correlation with the A step to the C step may be calculated only for the step extracted by the step information extracting unit 117 (the step estimated to be largely changed due to modification).

Here, the “start date” is the start date of use of the data for calculating the correlation, and the “completion date” is the completion date of use of the data for calculating the correlation. That is, based on the data from the start date of use to the completion date of use, the modification influence output unit 118 calculates the correlation of each process, in other words, a correlation coefficient (productivity) and a correlation coefficient (quality).

In addition, “modified step”, “modified product”, “modified part”, “spreading step”, “spreading product”, “spreading part” are the identical to FIG. 6.

Further, “measurement item” is an item of measured value information used for correlation calculation, “correlation coefficient (productivity)” is a coefficient representing correlation for productivity information, and “correlation coefficient (quality)” is a coefficient representing a correlation for quality information.

For example, the case where the modified step is the A step and the correlation coefficient indicating the correlation between the A step and the L step is calculated will be described. In this case, first, the modification influence output unit 118 acquires the measured value in the A step. In this example, the value of the temperature measured in the A step from Jan. 1, 2017 to Dec. 19, 2017 is acquired. In addition, the modification influence output unit 118 acquires the productivity information of the L step from Jan. 1, 2017 to Dec. 19, 2017.

Here, in general, the correlation coefficient between X and Y which is a combination of two data is obtained by the covariance of X and Y, the standard deviation of X, and the standard deviation of Y. Thus, for example, from Jan. 1, 2017 to Dec. 19, 2017, the correlation coefficient (productivity) indicating the correlation between the A step and the L step is calculated, based on the combination of the plural time points, as a combination of the temperature of the A step at a certain time point and the productivity information of the L step.

Further, the correlation coefficient (quality) is calculated in the same way. Then, not only the correlation between the A step and the L step but also the correlation between the A step and other steps is calculated. In a case where the modified step is the B step, the correlation is calculated even for the case where the modified step is the C step.

Next, the modification influence output unit 118 calculates a proportional division value for proportionally dividing the productivity information and a proportional division value for proportionally dividing the quality information. FIG. 10B is a diagram showing an example of a proportional division value for proportionally dividing the productivity information and a proportional division value for proportionally dividing the quality information.

“Start date”, “completion date”, “modified step”, “modified product”, “modified part”, “spreading step”, “spreading product”, “spreading part”, “measurement item”, “correlation coefficient (productivity)”, and “correlation coefficient (quality)” are identical to those in FIG. 10A. Further, “productivity proportional division value” is a proportional division value for proportionally dividing the productivity information and “quality proportional division value” is a proportional division value for proportionally dividing the quality information.

Here, the modification influence output unit 118 calculates a proportional division value based on the value of the correlation coefficient. Specifically, for each of the productivity and the quality, the proportional division value is calculated such that the sum of the proportional division values of the modified steps (in this example, the A step to the C step) becomes 100%.

For example, as shown in FIG. 10A, the correlation between the L step and the A step is such that the correlation coefficient (productivity) is “0.7” and the correlation coefficient (quality) is “0.6”. Further, the correlation between the L step and the B step is such that the correlation coefficient (productivity) is “0.3” and the correlation coefficient (quality) is “0.4”. Further, the correlation between the L step and the C step is such that both the correlation coefficient (productivity) and the correlation coefficient (quality) are “0”.

The modification influence output unit 118 calculates the proportional division value, based on the values of these correlation coefficients. Since there is no correlation between the L step and the C step, the C step is excluded from the calculation of the proportional division value.

For example, regarding the productivity of the L step, the correlation coefficient (productivity) with the A step is “0.7” and the correlation coefficient (productivity) with the B step is “0.3”. Therefore, the productivity proportional division value in the A step is calculated as 0.7/(0.7+0.3)=70%. Further, the productivity proportional division value in the B step is calculated as 0.3/(0.7+0.3)=30%. Further, regarding the quality of the L step, the correlation coefficient (quality) with the A step is “0.6” and the correlation coefficient (quality) with the B step is “0.4”. Therefore, the quality proportional division value in the A step is calculated as 0.6/(0.6+0.4)=60%. Further, the quality proportional division value in the B step is calculated as 0.4/(0.6+0.4)=40%.

Next, the modification influence output unit 118 proportionally divides the productivity information and the quality information of the L step according to the proportional division value. Here, as shown in FIG. 9B, the amount of change due to the modification of the productivity information is 110 units−100 units=10 units, and the production modification rate is (110 units−100 units)/100 units=10%. In addition, the amount of change due to the modification of the quality information is 4 units−2 units=2 units, and the quality modification rate is 2 units/4 units=50%.

In addition, the production modification rate (10%) of the L step is the result of modification in the A step and the B step, and the proportional division values of these modifications are 70% and 30%, respectively. That is, it can be said that the modification of the A step contributes 70% and the modification of the B step contributes 30% to the production modification rate (10%).

Therefore, the modification influence output unit 118 calculates the production modification rate for the A step as the total production modification rate (10%)×(70%/100%)=7%. Similarly, the modification influence output unit 118 calculates the production modification rate for the B step as the total production modification rate (10%)×(30%/100%)=3%.

Further, the modification influence output unit 118 calculates the quality modification rate for the A step as the total quality modification rate (50%)×(60%/100%)=30%. Further, the modification influence output unit 118 calculates the quality modification rate for the B step as the total quality modification rate (50%)×(40%/100%)=20%.

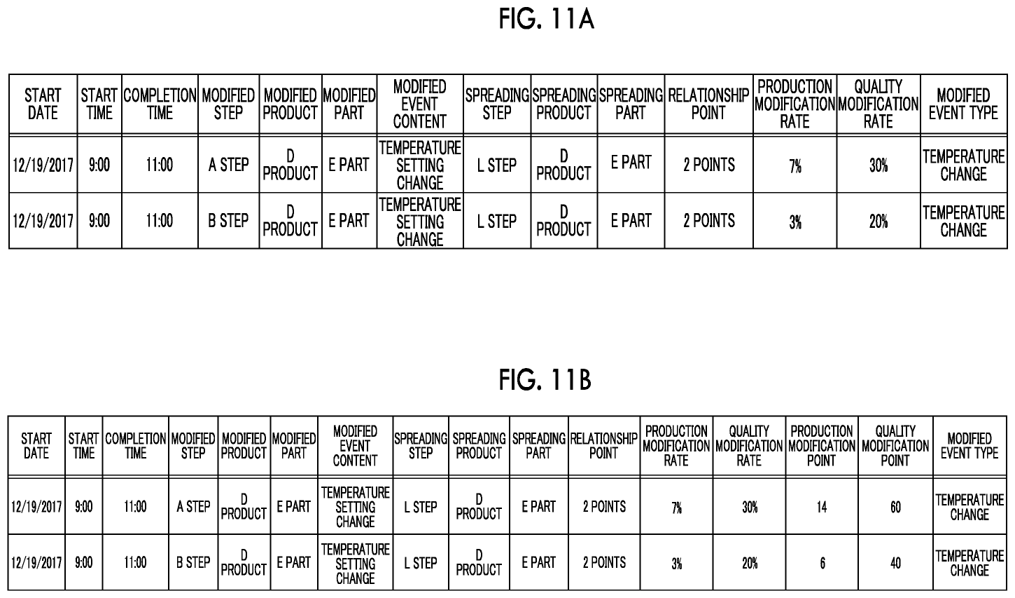

FIG. 11A is a diagram showing an example in the case where the production modification rate and the quality modification rate are proportionally divided for each modified step with respect to the L step. In the illustrated example, similarly to FIG. 7, the relationship point, the production modification rate, and the quality modification rate are shown for the L step. As described above, the production modification rate and the quality modification rate for the A step are 7% and 30%, respectively. Further, the production modification rate and the quality modification rate for the B step are 3% and 20%, respectively.

Although the L step is not within three steps from the A step and the B step, “spreading product” and “spreading part” of the L step are D product and E part, and are identical to “modified product” and “modified part”, so the relationship point is 2 points.

Next, the modification influence output unit 118 reflects the relationship point to the productivity information and the quality information of the L step, and outputs the information in which the relationship point is reflected. FIG. 11B is a diagram showing an example in the case where the production modification point and the quality modification point are calculated for each modified step for the L step. In the example shown in FIG. 11B, in a case where the modified step is the A step, the production modification point is calculated as the production modification rate (7%) for the A step×the relationship point (2 points)=14 points, and the quality modification point is calculated as the quality modification rate (30%) for the A step×the relationship point (2 points)=60 points. Similarly, in a case where the modified step is the B step, the production modification point is calculated as the production modification rate (3%) for the B step×the relationship point (2 points)=6 points, and the quality modification point is calculated as the quality modification rate (20%) for the B step×the relationship point (2 points)=40 points.

Various types of information of FIG. 11B including the production modification point and the quality modification point are stored in the modification influence information DB 119. Therefore, by referring to the information stored in the modification influence information DB 119, the user can recognize the extent of the change due to the modification of the steps A to C, based on the production modification point and the quality modification point of the L step.

In this example, the production modification point and the quality modification point are output for each of the modified steps, for the L step, but, for example, the production modification point and the quality modification point may be output for each of other steps (A step to Z step other than the L step), or the production modification point and the quality modification point may be output only for the step extracted by the step information extracting unit 117 (the step estimated to be largely changed due to modification).

In this example, the temperature value is used as the measured value information used for calculating the correlation coefficient, but the measured value information (the type of the measured value information) maybe determined according to the content of modification.

For example, in a case where the modified event type is “temperature change”, the correlation coefficient is calculated based on the content of modification, by using the value of temperature as the measured value information, in calculating the correlation with the modified step. Therefore, it is easier to recognize the change due to modification than a case of using values other than temperature (for example, a pressure value). Therefore, for example, in a case where the modified event type is “temperature change”, the value of temperature is used as measured value information. For example, in a case where the modified event type is “pressure change”, the value of pressure maybe used as the measured value information, or in a case where the modified event type is “humidity change”, the value of humidity may be used as the measured value information. Further, for example, in a case where the modified event type is “work improvement” and the modified content is “seal pressure increase”, because the adhesiveness of the seal changes depending on the temperature (product temperature), the value of temperature may be used as measured value information.

In this example, the correlation coefficient is calculated using the measured value information and the proportional division value is calculated using the calculated correlation coefficient, but a method of proportionally dividing the production improvement rate and the quality improvement rate for each modification is not limited to such a configuration. In the present exemplary embodiment, the production improvement rate and the quality improvement rate may be proportionally divided for each modification, and for example, the proportional division value may be calculated according to the content of modification or the content of the modified step, or the proportional division value may be calculated based on the relationship point.

Further, in this example, the modification is performed in plural different steps, but the present exemplary embodiment can also be applied to a case where plural modifications are performed in one step. In the case where plural modifications are performed in one step, this step can be further divided into two or more steps for each modification, and it can be regarded as a modification of two or more steps. Then, for example, by calculating the correlation between the part divided for each modification and the other steps, the production improvement rate and the quality improvement rate may be proportionally divided for each modification.

As described above, the modification effect output apparatus 100 according to the present exemplary embodiment outputs information indicating a change before and after the modification is performed, for each individual step, in a case where a predetermined work is modified. With such a process, the user can recognize the change due to the modification with respect to each individual step.

In addition, the modification effect output apparatus 100 specifies a step estimated to be largely changed due to the modification, or reflects the relationship between the modified step and each individual step depending on the relationship point. With such a process, it is easy to recognize the change due to the modification.

Further, in a case where plural modifications are performed, by proportionally dividing the amount of change in productivity information and quality information for each modification, it is easy to recognize the influence of each modification.

In the example described above, the modification effect output apparatus 100 outputs the productivity information and the quality information before and after the modification, but at least one of the productivity information or the quality information may be output as a change due to the modification. In other words, the modification effect output apparatus 100 may output only one of the productivity information and the quality information.

Further, in the above-described example, in a case of modifying a predetermined work, any one of plural steps included in the predetermined work is modified, but modification includes a case of deleting a step. Further, in a case of modifying a predetermined work, a new step may be added to the predetermined work. That is, in the present exemplary embodiment, the modified step includes a step to be deleted from a predetermined work or a step to be added to the predetermined work. Even in a case where a step is deleted from a predetermined work or a new step is added, the modification effect output apparatus 100 outputs information indicating a change before and after the modification is performed, or outputs information in which a relationship point is reflected, with respect to plural steps included in the predetermined work.

Further, the program realizing the exemplary embodiment of the present invention can be provided not only by a communication unit but also by being stored in a recording medium such as a CD-ROM.

Although various exemplary embodiments and modification examples have been described above, it goes without saying that these exemplary embodiments and modification examples may be combined.

Further, the present disclosure is not limited to the above exemplary embodiment at all, and can be implemented in various forms without departing from the gist of the present disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires information on execution results of a plurality of steps, for the plurality of steps included in a predetermined work; and
an output unit that in a case where the predetermined work is modified, outputs information indicating a change before and after the modification is performed, for each individual step of at least some of the plurality of steps, based on the information on the execution results of the plurality of steps.

2. The information processing apparatus according to claim 1,
wherein the output unit outputs information indicating the change, for each individual step, based on a relationship between a step in which the modification is performed and the individual step.

3. The information processing apparatus according to claim 2,
wherein the output unit outputs information indicating the change, for a step subsequent to the step in which the modification is performed, excluding a step prior to the step in which the modification is performed.

4. The information processing apparatus according to claim 2,
wherein the output unit estimates that a first step which is a step subsequent to the step in which the modification is performed has a larger change due to the modification than a second step which is a step subsequent to the first step, and outputs information indicating the change.

5. The information processing apparatus according to claim 2,
wherein the output unit estimates that a step of handling the identical object to the object which is subjected to the modification in the step in which the modification is performed has a larger change due to the modification than a step of not handling the object, and outputs information indicating the change.

6. The information processing apparatus according to claim 5,
wherein the object which is subjected to the modification is a product generated by the predetermined work or a part included in the product.

7. The information processing apparatus according to claim 1,
wherein in a case where two or more steps are modified in the predetermined work, the output unit outputs information indicating a change corresponding to each of the two or more steps in which the modification is performed, for the individual steps.

8. The information processing apparatus according to claim 7,
wherein the output unit outputs information indicating a change corresponding to each of the two or more steps in which the modification is performed, based on correlation between the individual step and each of the two or more steps in which the modification is performed.

9. The information processing apparatus according to claim 8,
wherein the correlation is calculated from an execution result of the individual step and a measured value measured in each of the two or more steps in which the modification is performed.

10. The information processing apparatus according to claim 9,
wherein a type of the measured value used for calculating the correlation is determined by a content of the modification.

11. The information processing apparatus according to claim 1,
wherein a step in which the modification is performed is a step included in the predetermined work before the modification or a step added to the predetermined work by the modification.

12. A non-transitory computer readable medium storing a program causing a computer to implement:
a function of acquiring information on execution results of a plurality of steps, for the plurality of steps included in a predetermined work; and
a function of outputting, in a case where the predetermined work is modified, information indicating a change before and after the modification is performed, for each individual step of at least some of the plurality of steps, based on the information on the execution results of the plurality of steps.

13. An information processing apparatus comprising:
acquisition means for acquiring information on execution results of a plurality of steps, for the plurality of steps included in a predetermined work; and
output means for outputting, in a case where the predetermined work is modified, information indicating a change before and after the modification is performed, for each individual step of at least some of the plurality of steps, based on the information on the execution results of the plurality of steps.
